(19) United States
(12) Patent Application Publication
(10) Pub. No.: US 2018/0272540 A1
(43) Pub. Date: Sep. 27, 2018

(54) RESORT SANITATION MONITOR AND CONTROLLER

(71) Applicant: PANASONIC INTELLECTUAL PROPERTY MANAGEMENT CO., LTD., Osaka (JP)

(72) Inventors: John CRONIN, Bonita Springs, FL (US); Jonathan T. GOGUEN, Brookline, NH (US); Michael Glynn D'ANDREA, Burlington, VT (US); Mikio MORIOKA, Osaka (JP)

(21) Appl. No.: 15/468,955

(22) Filed: Mar. 24, 2017

(51) Int. Cl. B25J 11/00; B25J 9/16; G05D 1/00; H04W 4/02; G06K 9/00; H04N 7/18; G06T 7/70

(52) U.S. Cl. CPC B25J 11/0085; G06T 2207/30196; B25J 9/1664; G05D 1/0088; B25J 9/1697; G05D 1/0022; H04W 4/028; G06K 9/00771; G06K 9/00362; G06K 9/00335; H04N 7/181; G06T 7/70; Y10S 901/01; G06T 2207/30232; B25J 9/1694

(57) ABSTRACT

A sanitation monitoring and control system and associated method are used to route sanitation resources, such as sanitation robots configured to sweep, vacuum, or empty trash receptacles, in a facility. The system includes a network of sensors disposed throughout the facility and configured to sense patrons within the facility. A sanitation monitoring and control server stores records of patron positions at different times determined using the network of sensors, determines numbers of patrons in different areas of the facility at the different times according to the patrons' determined positions, determines activities patrons are engaged in in the different areas at the different times, and calculates sanitations scores for the areas according to a weighted sum of the numbers of patrons engaging in the determined activities. A route for the sanitation resource is calculated based on the sanitation scores and is transmitted to the sanitation resource to provide sanitation services.

### TECHNICAL FIELD

The present subject matter relates to techniques and equipment to provide sanitation and waste monitoring and control, for example in resorts, amusement parks, or other facilities.

### BACKGROUND

Considerable resources are expended in large scale facilities such as resorts and amusement parks to maintain a clean environment for patrons. For example, a groundskeeping supervisor needs to make periodic rounds throughout the facilities to identify areas in need of litter pick-up or other clean-up and sanitation needs. In turn, once areas in need of sanitation are identified, the groundskeeping supervisor needs to notify the appropriate workers or crews and/or deploy appropriate sanitation resources (e.g., trucks, sweepers, or the like). The process of monitoring the facilities and deploying crews is inefficient, and occupies supervisors and workers that could otherwise be providing litter pick-up or other sanitation services.

A need therefore exists for systems that can monitor facilities' sanitation needs, can automatically identify locations in need of sanitation, can identify resources needed (e.g., crews and equipment), and can deploy the identified sanitation resources to the locations of highest need based on real-time tracking of the sanitation needs of the facilities.

### SUMMARY

The teachings herein alleviate one or more of the above noted problems by providing sanitation monitoring and control services in resorts, amusement parks, or other facilities.

In accordance with one aspect of the disclosure, a sanitation monitoring and control system for use in a facility includes a plurality of waste receptacles, a patron sensing subsystem, a sanitation robot, a communication network, and a processing subsystem. The plurality of waste receptacles are each configured to monitor a trash level of the respective receptacle, and to communicate wirelessly with other components of the sanitation monitoring and control system. The patron sensing subsystem is configured to sense patrons within the facility, and to communicate patron sensing information to other components of the sanitation monitoring and control system for determining positions of the patrons. The sanitation robot is configured to move autonomously in the facility and to communicate wirelessly with other components of the sanitation monitoring and control system. The communication network provides wireless communication services between components of the sanitation monitoring and control system including the waste receptacles, the patron sensing subsystem, and the sanitation robot. The processing subsystem is communicatively connected via the communication network to the waste receptacles, the patron sensing subsystem, and the sanitation robot; is configured to receive trash level information and patron sensing information from the waste receptacles and the patron sensing subsystem; and is configured to control the sanitation robot to move autonomously in the facility along a route determined by the processing subsystem.

In accordance with another aspect of the disclosure, a sanitation monitoring and control system for routing sanitation resources in a facility includes a network of sensors and a sanitation monitoring and control server. The network includes sensors disposed at different locations throughout the facility, and configured to sense patrons within the facility and to communicate patron sensing information to other components of the sanitation monitoring and control system. The sanitation monitoring and control server is configured to store in one or more databases records identifying positions of patrons in the facility at a plurality of different times determined according to the patron sensing information provided by the network of sensors. The sanitation monitoring and control server further determines, for each respective area of a plurality of areas in the facility, a number of patrons in the respective area at each of the plurality of different times, and determines, for each respective area of the plurality of areas and each of different respective activities, numbers of patrons engaging in the respective activity in the respective area at each of the plurality of different times. The sanitation monitoring and control server calculates, for each respective area of the plurality of areas, a sanitation score for the respective area as a weighted sum of numbers of patrons estimated to engage in the different activities in the area, wherein the different activities are assigned different weights in the weighted sum; calculates, based on the sanitation scores calculated for the plurality of areas, a route for the sanitation resource; and transmits the calculated route to the sanitation resource to control the sanitation resource to provide sanitation services along the calculated route.

In accordance with a further aspect of the disclosure, a sanitation monitoring and control method for routing sanitation resources in a facility includes storing in one or more databases, by a sanitation monitoring and control server communicatively connected to a network of sensors disposed at different locations throughout the facility and configured to sense patrons within the facility, records identifying positions of patrons in the facility at a plurality of different times determined according to the patron sensing information provided by the network of sensors. The method further includes determining, by the sanitation monitoring and control server, for each respective area of a plurality of areas in the facility, a number of patrons in the respective area at each of the plurality of different times; determining, by the sanitation monitoring and control server, for each respective area of the plurality of areas and each of different respective activities, numbers of patrons engaging in the respective activity in the respective area at each of the plurality of different times; calculating, by the sanitation monitoring and control server, for each respective area of the plurality of areas, a sanitation score for the respective area as a weighted sum of numbers of patrons estimated to engage in the different activities in the area, wherein the different activities are assigned different weights in the weighted sum; calculating, by the sanitation monitoring and control server, based on the sanitation scores calculated for the plurality of areas, a route for the sanitation resource; and transmitting, from the sanitation monitoring and control server, the calculated route to a sanitation resource configured to provide sanitation services to control the sanitation resource to provide the sanitation services along the calculated route.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIGS. 1A and 1B are high-level functional block diagrams of illustrative waste receptacles for use in sanitation monitoring and control systems.

FIG. 2 is a high-level block diagram showing a facility having an associated sanitation monitoring and control system, and showing components of the sanitation monitoring and control system located throughout the facility.

FIG. 3 is a high-level functional block diagram of a sanitation monitoring and control system for use in the facility shown in FIG. 2.

FIG. 4 is a high-level flow diagram showing steps of an exemplary sanitation monitoring and control method that can be implemented by a sanitation monitoring and control system such as that shown in FIG. 3.

FIGS. 5 and 6 are simplified functional block diagrams of processing platforms that may be configured for use in components of the sanitation monitoring and control system of FIG. 3.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to sanitation and waste monitoring and control. The sanitation and waste monitoring and control provides for the automated identification of sanitation needs in a facility such as a resort, amusement park, theme park, or the like through the use of various sensing systems. The sanitation needs may include litter pick-up and removal, emptying of trash containers, cleaning/sweeping/moping/wiping of surfaces, and the like. The system further controls sanitation resources (e.g., sanitation crews, robotic cleaners, and the like) and can efficiently route appropriate sanitation resources in real time through the facility to ensure that identified sanitation needs are addressed within short response times throughout the facility.

Reference now is made in detail to the examples illustrated in the accompanying drawings and discussed below.

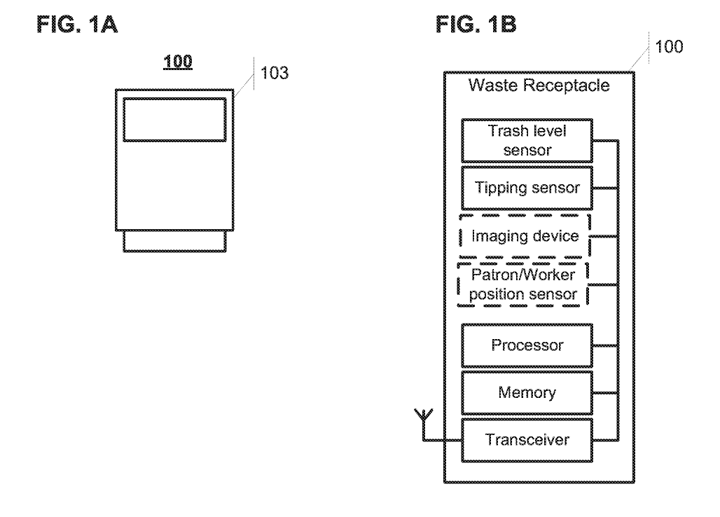

FIGS. 1A and 1B illustrate a waste receptacle 100 that can be used as part of a sanitation monitoring and control system. The waste receptacle 100 can take the form of a network-connected trash can. In such examples, the waste receptacle 100 has a body 103 which includes a cavity for receiving and/or storing trash, as shown in FIG. 1A. The body includes at least one opening through which trash or other waste can be received.

From a functional perspective, the waste receptacle 100 includes one or more processor(s) and memory(ies) operative to control operation of the receptacle 100 (see, e.g., FIG. 1B). The processor, which may be a microprocessor, serves as a programmable controller for the receptacle 100, in that it controls all operations of the receptacle 100 in accord with programming that it executes, for all normal operations, and for operations involved in the monitoring of waste and litter under consideration here. The memory includes non-volatile memory storing program instructions for execution on the processor, as well as operational data used in performing the various methods described herein. In addition, the receptacle 100 includes sensors such as a trash level sensor that monitors the level of trash currently present in the receptacle 100 and communicates the monitored level to the processor. The trash level sensor can be a mechanical, optical, weight, or other sensor. In examples in which receptacle 100 is capable of compacting trash, the trash level sensor may be connected to the compactor so as to sense a level of the compacted trash whenever the trash compactor is activated.

Additionally, the receptacle 100 includes a tipping sensor used to determine whether the receptacle 100 has been tipped over or otherwise disturbed. The tipping sensor can take the form of a gravity sensor, a level or tilt sensor, an accelerometer, or other appropriate tilt-determining unit mounted in or on the receptacle 100 and communicatively connected to the processor. However, while the tipping sensor is shown as being mounted in the receptacle 100 in FIG. 1B, the tipping sensor can in some embodiments be mounted outside of the receptacle 100 such as on a surface, post, or other support for the receptacle 100.

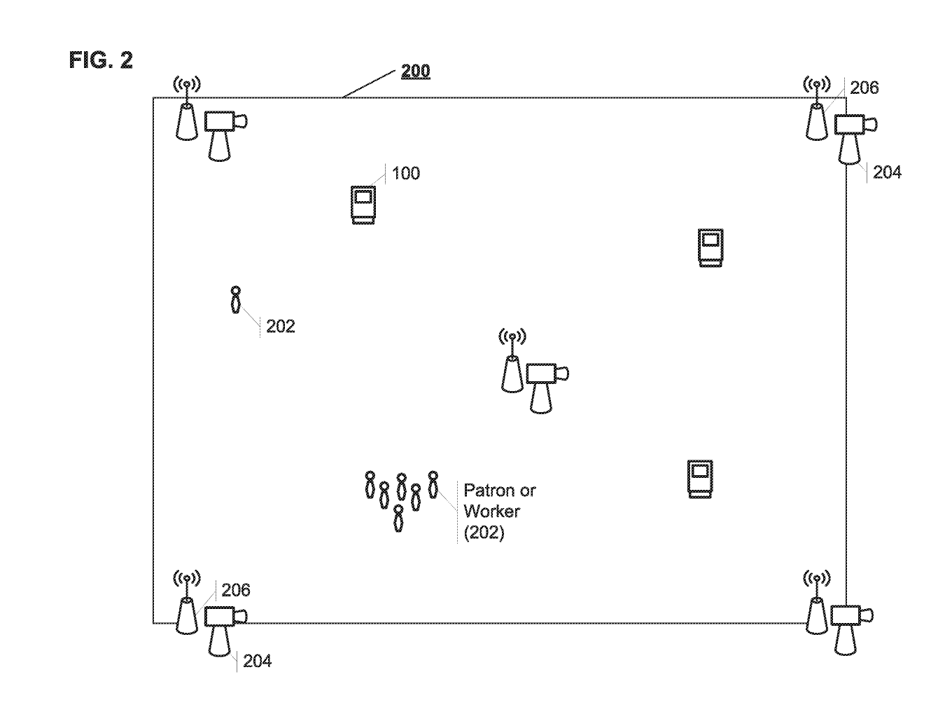

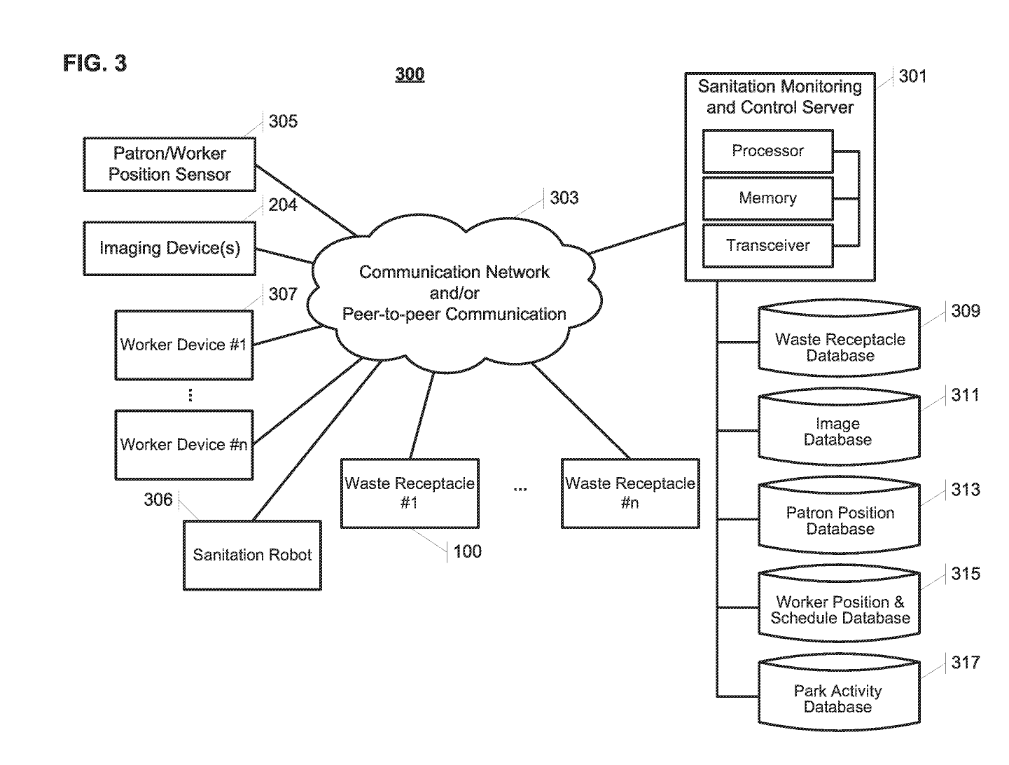

The waste receptacle 100 additionally includes a power source (not shown) such as a battery-based and/or photo-voltaic power source used to power its operation including operation of the sensors, the processor(s), and the like. Finally, the receptacle 100 optionally includes one or more additional sensor(s) such as an imaging device or sensor configured to capture images of one or more areas surrounding the receptacle 100 and a patron and/or worker position sensor configured to sense the presence, position, and/or movement of patrons, workers, or other persons in the areas surrounding the receptacle 100. Each sensor is communicatively connected to the processor. A transceiver enables the waste receptacle 100 to communicate through a wired or wireless connection with other components of the sanitation monitoring and control system. The imaging device and patron/worker position sensor will be described in more detail in relation to FIGS. 2 and 3 below.

The waste receptacle 100 operates within a facility 200 such as a resort, theme park, amusement park, or the like. FIG. 2 shows one such illustrative facility 200 in which multiple waste receptacles 100 are located. The facility 200 has patrons, workers, and/or other persons 202, such as guests and visitors, present and moving about within the facility 200. These persons may generate waste and/or provide sanitation services. Additionally, imaging devices 204, such as still or video cameras, are located throughout the facility 200. The imaging devices 204 can include cameras used for security and loss-prevention as well as cameras used exclusively as part of a sanitation monitoring and control system, The imaging devices 204 may be mounted on waste receptacles 100 (see, e.g., FIG. 1B) or mounted on various other structures or at other locations within the facility 200 such as on light posts, buildings, awnings, ceilings, or the like. Each imaging device 204 is used to capture still or video images of a respective area of the facility 200, such as an area adjacent to or surrounding a waste receptacle 100, and to transmit the captured images to a server via a wired or wireless communication link.

For purposes of sanitation monitoring and control, distinct areas are defined in the facility 200 and the sanitation needs of the different areas are separately evaluated to identify the areas with the highest needs for sanitation services at any time. The areas are functionally defined, and may or may not correspond to structurally distinct areas within the facility. In general, the areas are distinct from each other and non-overlapping. In the following description, each area is associated with a particular waste receptacle 100 and is identified by the same identifier as the associated waste receptacle (e.g., r1, r2, . . . ). For example, each area may correspond to a circular or square area surrounding the waste receptacle 100. More generally, however, the sanitation methods described herein can be applied to areas without any associated waste receptacles, and/or to areas in which multiple waste receptacles are provided. Additionally, in the following description, the imaging device(s) 204 and the images captured thereby are each associated with a corresponding one of the areas (and associated with the waste receptacle identifier r1, r2, . . . corresponding to the one area) on the basis that images captured by the image device 204 are images of the one area or of a portion thereof.

The facility 200 further includes antennas 206 disposed throughout the facility 200. The antennas 206 can form the backbone of a wireless communication network supporting wireless communications between elements of the sanitation monitoring and control system described herein. For this purpose, the antennas 206 can be communication antennas used to communicate wirelessly with individual waste receptacles 100, imaging devices 204, and other components of the sanitation monitoring and control system. The antennas 206 can further support wireless communications between each other, or can be connected via a wired network to a central processing server. In some examples, the antennas 206 (e.g., the same antennas used for communication functions, or different antennas) can be used as sensors or the facility 200 can include a separate set of sensors disposed throughout the facility, such as sensors used to sense the positions and/or movement of persons 202 (e.g., patrons and workers) in the facility 200 (such as the patron/worker position sensor described in relation to FIG. 1B, above).

The monitoring of sanitation needs and control of sanitation resources in the facility 200 is performed by a sanitation monitoring and control system 300, an illustrative example of which is shown in FIG. 3. The sanitation monitoring and control system 300 includes the waste receptacles 100, imaging devices 204, and other components described above, as well as further components described below.

While various components of the sanitation monitoring and control system 300 are shown as being physically separate from each other in FIG. 3, the components may in some examples be combined together. For example, while the imaging device(s) 204 and patron/worker position sensors 305 are shown as distinct components in FIG. 3, they may in some examples be included within the individual waste receptacles 100 (see, e.g., FIG. 1B). Additionally, functions and processing described herein as being performed by the sanitation monitoring and control server 301 of FIG. 3 may more generally be performed by the processor(s) of waste receptacle(s) 100, of worker device(s) 307, or of other components in certain embodiments, or performed in a distributed fashion across processors of multiple components.

As shown in FIG. 3, the sanitation monitoring and control system 300 includes one or more (e.g., n, where n is a positive integer) waste receptacles 100 such as the waste receptacles 100 described above. The system 300 can also include one or more sanitation robots 306 such as robotic mechanical sweepers, cleaners, or vacuums, a robotic sanitation cart or truck, or the like. The sanitation robots 306 are a sanitation resource, and can autonomously provide sanitation services including sweeping, cleaning, and vacuuming to, for example, remove litter, clean floors and other surfaces, empty waste receptacles, and the like. A sanitation robot 306 typically includes a motor and tracks, wheels, or other appropriate systems for enabling the robot 306 to autonomously move about a facility. Through the use and control of the motor, the robot 306 can autonomously move about the facility. In a preferred embodiment, each robot 306 includes a processor, memory, and a transceiver configured for wireless communication with other components of the sanitation monitoring and control system 300. The robot 306 can, for example, receive via the transceiver a route or control instruction from the system 300 and, in response, autonomously operate to follow the route or perform the control instruction.

The system 300 further includes sensors and/or data sources including a patron/worker position sensing subsystem that relies on patron/worker position sensor(s) 305 to sense or otherwise determine the positions of persons 202 within the facility 200. The patron/worker position sensing subsystem can include GPS units or other appropriate position-determining units carried by persons (guests and/or workers), such as GPS units provided in portable devices such as tablet computers, mobile devices, or smartphones. In such examples, the portable devices (e.g., smart phones) may be configured to transmit position data obtained from the GPS units to the sanitation monitoring and control server 301 on a periodic basis (e.g., every minute, every five minutes, or the like) while a person is in the facility 200. The patron/worker sensing subsystem can additionally or alternatively include position sensors configured to determine the positions of individual persons by, for example, triangulating the positions based on known positions of antennas 206 that are used to communicate with the persons' portable devices or other accessories. For instance, the triangulation of position may be performed based on sensing signals communicated to/from portable devices (e.g., smartphones) carried by the persons or to/from RFID-enabled or NFC-enabled devices such as access cards, wristbands, bracelets, or the like that are carried by the persons. The patron/worker sensing subsystem can additionally or alternatively include a network of sensors configured to count or otherwise sense and quantify numbers of persons within each sensor's proximity, such as through image-analysis of images captured by the sensors. For instance, the patron/worker position sensing subsystem can make use of cameras (e.g., security or surveillance cameras, and/or image devices 204) mounted throughout the facility 200 to detect and recognize each person's face in images captured by the cameras using facial recognition, and to determine each person's location based on the known location of cameras having captured the images in which various guests' faces are recognized. In such an example, each person's facial data can be captured when the person enters the facility 200 and used to identify the person in images captured by the security or surveillance cameras.

The system 300 also includes imaging devices 204, which are used to capture images of various respective areas within the facility 200 and transmit the captured images to an image database 311 for storage and use by the sanitation monitoring and control server 301. The image database 311 stores, for each imaging device 204, a historical record of images captured by the imaging device 204 along with a timestamp for each image. The use of the captured images for sanitation monitoring and control in described in further detail below.

In some embodiments, workers (e.g., sanitation crew workers) in the facility use worker devices 307. The worker devices 307 can take various forms, including the form of portable electronic devices such as tablet computers, smartphones, PDAs, or the like. The worker devices 307 can be used by the sanitation monitoring and control system 300 to communicate information to workers, such as to communicate a schedule, task list, route, or the like to the workers. For this purpose, the worker devices 307 have graphical user interfaces (GUIs), e.g., a touch-sensitive display or other combination of user input and output interfaces. The worker devices 307 can also be used to determine workers' positions in the facility 200 and communicate the positions to the sanitation monitoring and control system 300. The worker devices 307 communicate with the sanitation monitoring and control system 300 through the network 303 or other communication link. While the worker devices 307 generally are portable devices that communicate wirelessly with the system 300, in some examples stationary devices (e.g., desktop computers, all-in-one computers, other computer portals or terminals, and the like) can be used. The worker devices 307 can also form part of or be integrated in sanitation equipment, and may for example take the form of a touch-screen mounted in a cart, truck, mechanical sweeper, or the like.

The sanitation monitoring and control system 300 additionally maintains databases storing various types of data. The databases include a waste receptacle database 309 storing information on the positions of the waste receptacles 100 in the facility 200; an image database 311 storing current and previous images captured by the imaging devices 204; a patron position database 313 storing information on the current and historical (e.g., previous) positions of the patrons in the facility 200; and a worker position and schedule database 315 storing information on the current and historical (e.g., previous) positions of workers in the facility 200 as well as information on workers past, present, and future schedules. The workers' schedules can include information on whether a worker is on-duty or off-duty at any time, whether a worker is available or is scheduled to perform a task at any time, whether a worker is scheduled to be at a particular location or position at any time, and the like. Finally, a park activity database 317 stores records of activities scheduled to take place in the facility 200, each record including a timestamp and identification of one or more location(s).

Illustrative examples of data stored in each of the databases 309, 311, 313, 315, and 317 are shown in the following Tables 1-5:

TABLE 1
Waste Receptacle Database (309)

| Receptacle | | Current Cleanliness |
|---|---|---|
| Identifier | Position | of Area |
| r1 | (10, 20) | Good |
| r2 | (15, 85) | Bad |
| r3 | (45, 50) | Excellent |
| . . . | . . . | . . . |

TABLE 2
Image Database (311)

| Receptacle | | | |
|---|---|---|---|
| Identifier | Date/time Stamp | Image Data | Patron Volume |
| r1 | 10/21 - 10:00am | 09231000R1.jpg | 30 |
| r1 | 10/21 - 11:00am | 09231100R1.jpg | 27 |
| . . . | . . . | . . . | . . . |
| r1 | 10/22 - 10:00am | 10210000R1.jpg | n/a |
| r2 | 10/21 - 10:00am | 09231001R1.jpg | 3 |
| . . . | . . . | . . . | . . . |

TABLE 3
Patron Position Database (313)

| Patron | | |
|---|---|---|
| Identifier | Date/time Stamp | Position |
| p1 | 10/22 - 10:00:00am | (40, 40) |
| p1 | 10/22 - 10:00:30am | (40, 45) |
| . . . | . . . | . . . |
| p2 | 10/22 - 10:00am | (0, 10) |
| . . . | . . . | . . . |

TABLE 4
Worker Position and Schedule Database (315)

| Worker | | | |
|---|---|---|---|
| Identifier | Date/time Stamp | Position | Schedule |
| w1 | 10/22 - 9:59:00am | (10, 5) | off-duty |
| w1 | 10/22 - 10:00:00am | (10, 5) | available |
| w1 | 10/22 - 10:00:30am | (15, 0) | available |
| . . . | . . . | . . . | . . . |
| w2 | 10/22 - 10:00am | (70, 60) | litter pick-up |
| . . . | . . . | . . . | . . . |

TABLE 5
Park Activity Database (317)

| | | | | | | | Park Activity | | |
|---|---|---|---|---|---|---|---|---|---|
| Receptacle | Date/time | Patron | Patron Activity | | | | Food | | |
| Identifier | Stamp | Volume | Walking | Waiting | Eating | . . . | Stand | Parade | . . . |
| r1 | 10/21- | 30 | 5 | 20 | 2 | . . . | No | Yes | . . . |
| | 10:00 am | | | | | | | | |
| r1 | 10/21- | 27 | 20 | 3 | 1 | . . . | No | No | . . . |
| | 11:00 am | | | | | | | | |
| r1 | 10/21- | 25 | 3 | 1 | 20 | . . . | Yes | No | . . . |
| | 12:00 pm | | (12%) | (4%) | (80%) | | | | |
| . . . | . . . | . . . | | | | . . . | | | |

The databases 309-317 can be populated with known data values, when known, during initial set-up for the sanitation monitoring and control system 300. These initial values can be updated, as needed, when changes are made to the system 300. For example, the waste receptacle database 309 (see, e.g., Table 1) can be pre-populated with a list of waste receptacle identifiers and the receptacles' associated positions within the facility 200; imaging devices 204 can be associated with particular receptacles (or particular positions or areas, in other embodiments), such that each image captured by an imaging device 204 and stored in the image database 311 can be associated with the corresponding receptacle (or position, or area); the worker schedule database 315 can be pre-populated with data on different workers' work schedules (e.g., identifying when each worker is on or off duty, whether a worker is scheduled for performing any tasks, and the like); and the park activity database 317 can be pre-populated with data on activities scheduled to take place at different times in different locations in the facility 200. In one example, the park activity database 317 can thereby identify, for each waste receptacle (e.g., r1, r2, . . . ) or area, the park activities scheduled to take place in the area associated with the waste receptacle (e.g., as shown in Table 5, above) such as whether a parade is scheduled to take place in the area or whether a food stand is scheduled to be opened/operational in the area.

Operation of the sanitation monitoring and control system 300 is performed based on processing performed by a processing subsystem having one or more processors including processor(s) included in individual waste receptacles 100. In addition, the processing subsystem can include one or more sanitation monitoring and control server(s) 301 providing communication and/or processing capabilities for supporting operation of the system 300. As shown, a sanitation monitoring and control server 301 can include one or more processor(s), memory (including non-transitory memory) for storing programming instructions for execution by the processor(s), and one or more transceiver(s) for communicating with components of the system 300. The sanitation monitoring and control server 301 is also communicatively connected to the databases 309-317 (and/or may be co-located with or include the databases 309-317). Processing performed by the processing subsystem of the sanitation monitoring and control system 300, including processing performed to provide monitoring of sanitation needs and control sanitation resources, can be performed in a distributed fashion across processors of the processing subsystem including processors of the receptacle(s) 100 and server(s) 301.

The components of the sanitation monitoring and control system 300 are communicatively interconnected by a communication network 303 and/or by peer-to-peer or other communication links between components of the system 300. In one example, the waste receptacles 100 are communicatively connected through a wireless network, such as a Wi-Fi based wireless communication network, a mobile wireless network, or the like, providing wireless communication services throughout the facility 200. One or more antennas 206, which may include wireless access points, routers, and/or network repeaters, are provided to provide wireless communication coverage of the network 303 throughout the facility 200. The antennas 206 can be communicatively connected to each other and to the sanitation monitoring and control server(s) 301 through wired links such as Ethernet links.

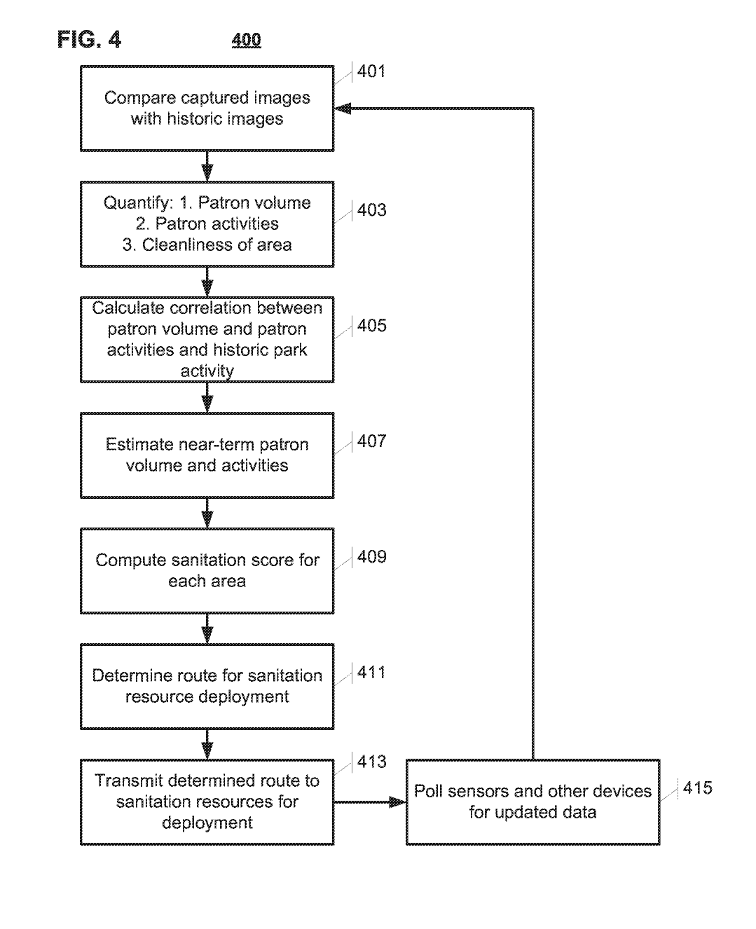

The operation of the sanitation monitoring and control system 300 will now be described in relation to the flow diagram of FIG. 4. FIG. 4 is a high-level flow diagram showing steps of a method 400 for sanitation monitoring and control. The method 400 can enable efficient management of waste and sanitation resources within a facility by automatically monitoring sanitation needs within the facility 200—such as identifying tipped trash receptacles and areas with high litter content—and routing sanitation resources (e.g., robotic mechanical sweepers, cleaners, and vacuums, sanitation workers, or the like) to identified areas to ensure prompt clean-up at all times of day. In this way, the method 400 can be used to ensure that waste, litter, and other sanitation needs are adequately and promptly addressed within the facility 200.

The method 400 makes use of current and historical data characterizing the facility 200, as well as data on patron volume and activities, scheduled events in the facility, and trash levels in waste receptacles that are obtained at least in part by sensors provided in the system 300 and stored in the databases 309-317, to monitor and efficiently allocate sanitation resources. Prior to performing step 401, the sanitation monitoring and control system 300 operates to collect current and historical data (e.g., data for current and previous/earlier time periods) from the sensors provided in the system 300. For example, images may be captured by the imaging devices 204 and stored in the image database 311, patron and/or worker positions for a plurality of earlier time periods can be captured by the position sensor(s) 305 and stored in databases 313 and 315, and, more generally, other sensing data can be captured to populate the databases 309-317 by storing the data collected from earlier time periods in the databases 309-317. The data can be collected automatically on a periodic basis (e.g., imaging devices 204 may be configured to provide updated images every hour), automatically as it is collected (e.g., trash level sensors may be configured to provide updated data in response to particular threshold levels being reached, such as increments of 5% in trash level), and/or in response to polling of the sensors, devices, and other system components by the processing subsystem (see, e.g., step 419 of method 400). The databases 309-317 can thus be populated and maintained with up-to-date data in real-time, and may further store a historic record of data from earlier time periods.

In step 401 of method 400, images newly captured by the imaging devices 204 are processed by the sanitation monitoring and control server 301. Specifically, images of different areas of the facility 200 captured by the imaging devices 204 and transmitted to the sanitation monitoring and control server 301 are processed in step 401 so as to quantify sanitation-related parameters in step 403. As part of the processing, the captured images can be compared to previous images of the same locations retrieved from the image database 311. The sanitation-related parameters that may be quantified based on the image data can include a patron volume parameter (e.g., measuring a number of persons located within each area), a patron or visitor activity parameter (e.g., counting numbers of persons partaking in particular activities in each area), and a cleanliness parameter (e.g., rating a cleanliness of each area). Each parameter can be quantified, at least in part, based on image analysis of a captured image of an area and based on stored images of the area captured at earlier time points and retrieved from the image database 311. For example, as shown in Table 2 (above), a patron volume parameter for a newly captured image (e.g., the image associated with the date/time stamp of 10/22—10:00 am in Table 2), which is identified as not available (n/a) in the Table, may be determined and stored in the database as a result of the quantification. In some examples (described in further detail below), the sanitation-related parameters can additionally or alternatively be quantified based on other sensing data.

The quantification of step 403 can be performed using different methods. As one option, the quantification can be performed by a human operator. The human operator, who may be using a worker device 307 or other computer terminal, may review captured images on a display of the device 307 and provide an estimated patron volume value for each reviewed image. The estimated patron volume value can then be stored in the databases 311 and 317 (see, e.g., Tables 2 and 5, above). Other approaches for automatically quantifying the parameters by the sanitation monitoring and control system 300 are commonly used. In one such alternative approach, patron or visitor volume is performed based on the positions of patrons determined by the patron/worker position sensor(s) 305. Specifically, based on the determined positions of patrons, a count of patrons within a particular area (e.g., an area associated with one trash receptacle 100, and within a sensing range of a patron/worker position sensor 305 mounted with the receptacle 100) is computed and the count number stored in the image database 311. Under an alternative approach, image processing is performed on images captured by the imaging device(s) 204 to determine patron count based at least in part on a comparison of a most recent image captured by an imaging device and at least one prior image captured by the imaging device. Based on the comparison of the images, a patron or visitor volume can be estimated, for example according to the procedure detailed in U.S. Pat. No. 9,025,875 which is incorporated by reference herein in its entirety. The comparison can involve steps for performing facial recognition (or recognition of other attributes of persons) and estimating the patron or visitor volume based on the recognition. Under a further approach, image processing is performed to identify, from among all images of a same area (e.g., all images captured by a same imaging device 204), the image that is most similar to the most recently captured image of the area. The most similar image can be identified according to the procedure detailed in U.S. Patent Publication No. 2011/0019003 (e.g., the described method implemented by the similar image searcher) which is incorporated by reference herein in its entirety. The patron or visitor volume for the most recently captured image is then set to the same value as the patron or visitor volume for the most similar image. Further approaches can involve estimating the patron or visitor volume based on a number of tickets sold, a number of patrons passing through a gate, or the like.

In addition to quantifying visitor volume, visitor activity can be quantified as shown in Table 5, above. The quantification of visitor activity can be performed using different methods, and can involve providing counts or estimates of numbers of patrons engaging in particular activities (e.g., walking, waiting in line, eating or lingering, or the like) within an area of the facility 200. As one option, the quantification of visitor activity can be performed by a human operator. The human operator, who may be using a worker device 307 or other computer terminal, may review captured images and provide an estimated count of patrons in each reviewed image that engage in each activity. The estimated counts of patron engaged in each activity can then be stored in the database 317 (see, e.g., Table 5, above). Other approaches for automatically quantifying the parameters by the sanitation monitoring and control system 300 are commonly used. In one such alternative approach, patron activity is determined based on patron movement pattern determined from a sequence of positions of each patron determined by the patron/worker position sensor(s) 305. Specifically, based on a sequence of position measurements for a patron (e.g., position measurements determined at 30 second intervals during a 3 minute time period), the patron's activity can be determined. In one example, if the patron has moved more than 100 meters during the time period (e.g., 3 minutes), the patron is determined to be walking; if the patron has moved less than 2 meters during the time period, the patron is determined to be static (e.g., eating), and if the patron has moved between 2 and 100 meters during the time period, the patron is determined to be waiting or queuing. Under an alternative approach, patron activity is determined based on patron position. In one example, if the patron is located in a portion of the area that is identified as a walkway or passageway, the patron is determined to be walking; if the patron is located in a food court or a seating portion of the area, the patron is determined to be static (e.g., eating); and if the patron is located in a queuing portion of the area, the patron is determined to be waiting or queuing. The determined counts of patrons engaged in each activity within each area is then stored in the park activity database 317. Under an alternative approach, image processing is performed on images captured by the imaging device(s) 204 to determine patron activity. The image processing can involve determining whether patrons in an image are in standing, seated, or walking positions for example by determining whether a patron's two legs are straight and parallel (standing), bent and parallel (seated), or bent and at different angles (walking). Further approaches can involve estimating the patron activities based on sales data (e.g., based on a number of patrons who should be queueing based on their timed ticket purchase, and/or based on sales volume at a food concession) or the like. The patron activity data can be expressed as a count of patrons engaged in each activity, or as a percentage of the patron volume for the area that is engaged in each activity (see, e.g., the third entry of Table 5, above).

Step 401 can further include determining a cleanliness parameter for the different areas of the facility 200. In one example, a 4-point cleanliness scale (excellent, good, average, or bad) is used as a cleanliness measure. The cleanliness parameter for each area can be determined by a human operator. The human operator, who may be using a worker device 307 or other computer terminal, may review captured images and provide an estimated cleanliness measurement value for each reviewed image. The estimated cleanliness measurement value can then be stored in the database 309 (see, e.g., Table 1, above). Other approaches for automatically quantifying the cleanliness parameter by the sanitation monitoring and control system 300 are commonly used. Under one such alternative approach, determination of cleanliness is performed based on image processing performed on images captured by the imaging device(s) 204 to determine cleanliness based at least in part on a comparison of a most recent image captured by an imaging device and at least one prior image captured by the imaging device. Based on the comparison of the images, an amount of litter found in the captured image can be estimated. The comparison can involve steps for performing litter recognition and estimating the cleanliness based on the recognition. For example, litter recognition can be performed using the method described in U.S. Patent Publication No. 2012/0002054 (e.g., the described method for detecting an object left behind) which is incorporated herein in its entirety, and a count of the number of pieces of litter identified can be used to establish the cleanliness score. Further approaches can involve estimating the cleanliness based on sales data (e.g., based on sales volume at a food concession located nearby, based on the particular items sold at the food concession, . . . ) or the like.

The automated processes for performing quantification in step 403 can additionally make use of machine learning algorithms to iteratively improve the accuracy of quantification. For example, in situations in which both an automated quantification and a human-operator-based quantification are performed, a machine learning algorithm may adjust parameters of the automated quantification procedure based on a difference between the quantified estimates provided by the automated quantification and by the human-operator-based quantification. The adjustment of the parameters can, over time, cause the quantification estimates provided by the automated methods to approximate those provided by human operators.

In turn, method 400 proceeds to step 405 in which correlations between patron volume, patron activities, and historic park activity are determined. The correlations are determined on the basis of the quantified data values determined in step 403 and other data values stored in the databases 309-317. The correlations can be subsequently used in step 407 to estimate near term patron volume and activity.

In step 407, near-term patron volume and patron activities are estimated. The estimation is based on current and past patron volume and patron activity data. The estimation can be performed for a future time point, so as to estimate a patron volume and numbers of patrons taking part in different activities at a next time point. In one example, time points are set hourly and the estimation is performed to calculate estimated/expected patron volume and patron activities at the next time point (e.g., in one hour). For instance, if the current time is 10:00 am, the estimation may be performed for a near-term future time of 11:00 am:

| | | | Patron Activity | | | | |
|---|---|---|---|---|---|---|---|
| | Date/time | Patron | Walk- | | | | Park |
| | Stamp | Volume | ing | Waiting | Eating | . . . | Activity |
| Current | 10/22- | 40 | 25 | 3 | 3 | . . . | None |
| time | 10:00 am | | | | | | |
| Near | 10/22- | | | | | . . . | Food |
| term | 11:00 am | | | | | | stand |
| future | | | | | | | |

In general, the estimation is performed by locating within the historic data recorded in the databases 309-317 a record having a similar pattern of patron volume, patron activity, and park activity as the data record for the current time. In the example detailed in the above table, for example, the park activity database 317 is consulted to locate a record having a similar patron volume (40), patron activity (25/40 walking, 3/40 waiting, 3/40 eating), and park activity (e.g., a food stand opening in the next hour) as the data for the current time point. In our example, the second row of Table 5 (provided above) may be identified as a closest match on the basis of that record including a food stand opening in the next hour and that record having a similar set of patron activity (20/27 walking, 3/27 waiting, 1/27 eating). The closest match can be identified by identifying records having matching park activity (e.g., in our example, a food stand opening in the next hour) and selecting, from among the identified records, the record having the smallest distance to the current data record. The smallest distance can be measured by plotting a point corresponding to each data record according to the patron activity for the record (e.g., a point having coordinates (20/27, 3/27, 1/27, . . . ) in the above example), and selecting the point closest to a point for the current data record. Once the closest match is identified, linear interpolation is used to predict the near-term future data. In our example, the data in the park activity database (see Table 5, above) indicates that following the food stand opening, patron volume fell by 7% (from 27 to 25) and patron activities changed such that 80% of patrons (20/25) engaged in eating, 4% in waiting, and 12% in walking. By linear interpolation based on the 40 patrons detected in the current record, the near-term future estimate is of 37 patrons (7% less than in the current data) of which 30 (i.e., 80%) will be eating, 1 (4%) will be waiting, and 4 (12%) will be walking.

| | | | Patron Activity | | | | |
|---|---|---|---|---|---|---|---|
| | Date/time | Patron | Walk- | | | | Park |
| | Stamp | Volume | ing | Waiting | Eating | . . . | Activity |
| Current | 10/22- | 40 | 25 | 3 | 3 | . . . | None |
| time | 10:00 am | | | | | | |
| Near | 10/22- | 37 | 4 | 1 | 30 | . . . | Food |
| term | 11:00 am | (−7%) | (12%) | (4%) | (80%) | | stand |
| future | | | | | | | |

Once the near-term patron volume and patron activities are estimated in step 407, the sanitation monitoring and control system 300 proceeds to step 409 in which a sanitation score is calculated for each area of the facility 200. The sanitation score is calculated based on the estimated near-term patron activity for the area as well as the area's rated cleanliness. In particular, the sanitation score is calculated as a weighted sum of the estimated number of patrons engaged in each activity (as determined in step 407), with each activity having a pre-determined weight factor. The sanitation score additionally takes into account the remaining space in the waste receptacle 100 for the area. In one example, weights related to patron activities are assigned as 0.01 for walking, 0.1 for waiting, and 0.5 for eating. Moreover, cleanliness parameters are translated into point values such that excellent cleanliness is assigned 1 point, good cleanliness is assigned 2 points, average cleanliness is assigned 3 points, and bad cleanliness is assigned 4 points. Finally, trash levels of 0%, 10%, 20%, 30%, 40%, 50%, 60%, 70%, 80%, 90%, and 100% are respectively assigned point values of 0, 1, 2, 3, 4, 5, 6, 7, 8, 9, and 10.

Hence, in accordance with step 409, a sanitation score can be calculated as follows for a first receptacle:

| Patron | Patron Activity | | | | | |
|---|---|---|---|---|---|---|
| Volume | Walking | Waiting | Eating | . . . | Cleanliness | Trash level |
| 37 | 4 | 1 | 30 | . . . | Good (2 pt) | 20% (2 pt) |

Sanitation score = 4 * .01 + 1 * .1 + 30 * .5 + 2 pt + 2 pt = 19.14 pt

And for a second receptacle:

| Patron | Patron Activity | | | | | |
|---|---|---|---|---|---|---|
| Volume | Walking | Waiting | Eating | . . . | Cleanliness | Trash level |
| 50 | 36 | 7 | 2 | . . . | Bad (4 pt) | 30% (3 pt) |

Sanitation score = 36 * .01 + 7 * .1 + 2 * .5 + 4 pt + 3 pt = 9.06 pt

In step 411, a route is determined for sanitation resources to be deployed throughout the facility 200 according to the calculated sanitation scores. Specifically, sanitation resources are routed in order to provide sanitation services to the areas according to the areas' sanitation scores. For example, areas with high sanitation scores may be prioritized to receive sanitation services promptly while areas having low sanitation scores may receive low priority. In one routing example, sanitation resources may be routed to the areas in descending order of sanitation scores such that the area with highest sanitation score is serviced first and the area with lower sanitation score is service last. In another routing example, both the sanitation scores and the locations of areas are taken into account in order to provide a route that prioritizes providing sanitation resources to areas having high sanitation scores but also takes into account the locations of areas in order to determine a route that most efficiently provides sanitation resources throughout the facility 200. Various routing algorithms including nearest neighbor routing algorithm, dynamic programming, local search, or a combination of linear programming and branch and bound programming can be used to establish the best route.

In step 413, the determined route is transmitted across the network 303 to ensure that the sanitation resources are routed along the determined route. In one example, the determined route is transmitted to a sanitation robot (e.g., a robot mechanical sweeper, robot mechanical cleaner, robot mechanical vacuum, or the like) to control the sanitation robot to automatically and autonomously follow the route and provide sanitation services to the areas with elevated sanitation scores. In another example, the determined route is transmitted to a sanitation vehicle (e.g., a car, truck, cart, personal mobility device, or the like) to control the sanitation vehicle to automatically follow the route or to display turn-by-turn directions for a driver to follow the route. In a further example, the determined route is transmitted to a worker device 307 to communicate the determined route to a sanitation worker and enable the sanitation worker to follow the route and provide appropriate sanitation services to the areas of highest need.

The process described above in relation to steps 401-413 can be repeated so as to continuously route the sanitation resources through the facility 200 in real-time. For this purpose, in step 415, the sensors and devices of the sanitation monitoring and control system 300 may be polled to obtain updated data (e.g., updated position, trash level, and image data) for the current time period. In turn, processing can return to step 401 so as to route the sanitation resources through the next time period.

In some examples, the sanitation monitoring and control server 301 computes routes for multiple sanitation resources in step 411, and the routes are transmitted to the appropriate sanitation resources in step 413. For example, a first route may be computed for a robot tasked with emptying waste receptacles 100, and the first route may be computed on the basis of trash levels in the waste receptacles 100 located throughout the facility. Second routes may be computed for mechanical sweeping robots, and the second routes may be computed on the basis of cleanliness of areas to ensure that the robots pick litter up from the areas with highest cleanliness scores. Both the first and second routes may be computed to avoid areas of high congestion (e.g., areas with high estimated patron volumes), and third routes may be computed to send teams of sanitation workers to areas with high congestion and high sanitation scores.

The step 413 for determining route(s) for sanitation resource(s) can, in one example, take into consideration current positions of sanitation resources including current positions of workers and schedules for the sanitation resources including workers' schedules. In such embodiment, routes are specifically determined for those sanitation resources (including sanitation workers) that are available (e.g., are not scheduled to perform other tasks at the same time), and the routes originate from the sanitation resources current positions. In this way, the efficiency of routing is improved by ensuring that the sanitation resources can follow the routes promptly without having to initially relocate to a beginning of the route.

The foregoing description has focused on one illustrative sequence of steps for monitoring sanitation needs and controlling sanitation resources in a facility. The ordering of the steps described above is illustrative, and the order of various steps can be changed without departing from the scope of the disclosure. Moreover, certain steps can be eliminated, and other steps added, without departing from the scope of disclosure. In one example, step 405 can be eliminated in some examples. In another example, step 415 can be performed continuously such that the sanitation monitoring and control system 300 receives updated sensing data at all times (e.g., even while steps 401-413 are being performed).

As shown by the above discussion, functions for providing sanitation monitoring and control services, via a sanitation monitoring and control system 300 such as that described herein, may be implemented on processing subsystems including processor(s) connected for data communication via the communication network 303 and operating in waste receptacles 100, worker device(s) 307, and/or in sanitation monitoring and control server(s) 301 shown in FIG. 3. Although special purpose devices may be used, such devices also may be implemented using one or more hardware platforms intended to represent a general class of data processing device commonly used to run “client” and “server” programming so as to implement the sanitation monitoring and control functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for implementing the sanitation monitoring and control method 400. The software code is executable by the general-purpose computer that functions as the sanitation monitoring and control server and/or that controls and allocates sanitation resources. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for sanitation monitoring and control in essentially the manner performed in the implementations discussed and illustrated herein.

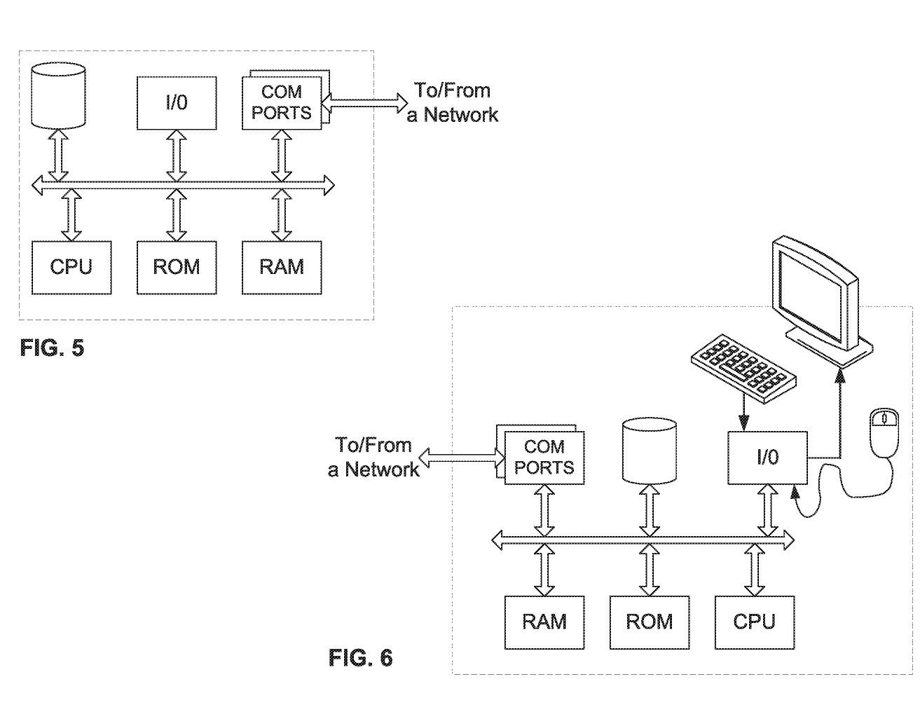

FIGS. 5 and 6 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A sanitation monitoring and control system for use in a facility, the sanitation monitoring and control system comprising:
a plurality of waste receptacles each configured to monitor a trash level of the respective receptacle, and to communicate wirelessly with other components of the sanitation monitoring and control system;
a patron sensing subsystem configured to sense patrons within the facility, and to communicate patron sensing information to other components of the sanitation monitoring and control system for determining positions of the patrons;
a sanitation robot configured to move autonomously in the facility and to communicate wirelessly with other components of the sanitation monitoring and control system;
a communication network providing wireless communication services between components of the sanitation monitoring and control system including the waste receptacles, the patron sensing subsystem, and the sanitation robot; and
a processing subsystem communicatively connected via the communication network to the waste receptacles, the patron sensing subsystem, and the sanitation robot, configured to receive trash level information and patron sensing information from the waste receptacles and the patron sensing subsystem, and configured to control the sanitation robot to move autonomously in the facility along a route determined by the processing subsystem.

2. The sanitation monitoring and control system of claim 1, wherein the processing subsystem is configured to control the sanitation robot to move autonomously along the route determined based on the trash levels monitored by the waste receptacles, patron positions determined according to the patron sensing information, and patron activities determined according to the patron sensing information.

3. The sanitation monitoring and control system of claim 1, wherein the patron sensing subsystem includes a plurality of antennas disposed at different locations throughout the facility, and wherein patron positions are determined according to wireless communications between the plurality of antennas and devices carried by the patrons.

4. The sanitation monitoring and control system of claim 3, wherein a patron activity is determined for each respective patron according to a movement pattern for the respective patron determined from a sequence of positions of the respective patron in the facility over time.

5. The sanitation monitoring and control system of claim 1, further comprising:
a plurality of imaging devices located at different locations in the facility and configured to capture images of different areas of the facility,
wherein the processing subsystem is configured to determine the route for the sanitation robot according to a cleanliness of the different areas of the facility rated based on the images captured by the imaging devices.

6. The sanitation monitoring and control system of claim 1, wherein the processing subsystem is configured to perform functions to:
maintain a patron position database identifying, for each of a plurality of time periods, the positions of patrons in the facility during the time period based on the patron sensing information communicated by the patron sensing subsystem;
update, based on patron sensing information received from the patron sensing subsystem, the patron position database to identify the positions of patrons in the facility during a current time period;
determine, for each patron position and each of the plurality of time periods in the patron position database, a patron activity according to a movement pattern for a respective patron determined from a sequence of positions of the respective patron in the facility over time;
calculate the route for the sanitation robot in the facility according to a weighted sum of numbers of patrons determined to take part in different activities, wherein different activities are assigned different weights in the weighted sum; and
transmit the calculated route to the sanitation robot across the communication network to control the sanitation robot to move autonomously in the facility along the calculated route.

7. The sanitation monitoring and control system of claim 6, wherein the processing subsystem calculates the route for the sanitation robot by performing functions to:
for each of a plurality of areas within the facility, count a number of patrons within the area for each of the plurality of time periods;
for each of the plurality of areas within the facility, estimate patron activities in one time period according to the number of patrons within the area for the one time period and activities of patrons within the area for a preceding time period;
for each of the plurality of areas within the facility, calculate a sanitation score for the area as the weighted sum of numbers of patrons estimated to take part in the different activities in the area, wherein different activities are assigned different weights in the weighted sum; and
calculate the route for the sanitation robot in the facility as a sequence of the areas ordered according to the calculated sanitation scores.

8. The sanitation monitoring and control system of claim 7, wherein the processing subsystem is configured to calculate the sanitation score for each of the plurality of areas within the facility according to the weighted sum of the numbers of patrons estimated to take part in the different activities in the area and the trash level of at least one waste receptacle in the area.

9. The sanitation monitoring and control system of claim 1, wherein the processing subsystem comprises a sanitation monitoring and control server communicatively connected to the waste receptacles, the patron sensing subsystem, and the sanitation robot across the communication network.

10. The sanitation monitoring and control system of claim 1, wherein the patron sensing subsystem receives patron position information from an electronic device carried by each patron.

11. A sanitation monitoring and control system for routing sanitation resources in a facility, the system comprising:
a network of sensors disposed at different locations throughout the facility, and configured to sense patrons within the facility and to communicate patron sensing information to other components of the sanitation monitoring and control system; and
a sanitation monitoring and control server configured to:
store in one or more databases records identifying positions of patrons in the facility at a plurality of different times determined according to the patron sensing information provided by the network of sensors;
determine, for each respective area of a plurality of areas in the facility, a number of patrons in the respective area at each of the plurality of different times;
determine, for each respective area of the plurality of areas and each of different respective activities, numbers of patrons engaging in the respective activity in the respective area at each of the plurality of different times;
calculate, for each respective area of the plurality of areas, a sanitation score for the respective area as a weighted sum of numbers of patrons estimated to engage in the different activities in the area, wherein the different activities are assigned different weights in the weighted sum;
calculate, based on the sanitation scores calculated for the plurality of areas, a route for the sanitation resource; and
transmit the calculated route to the sanitation resource to control the sanitation resource to provide sanitation services along the calculated route.

12. The sanitation monitoring and control system of claim 11, wherein the sanitation resource is a sanitation robot configured to move autonomously in the facility and to communicate wirelessly with other components of the sanitation monitoring and control system, and
the sanitation monitoring and control server is configured to control the sanitation robot to move autonomously in the facility along the calculated route by transmitting the calculated route to the sanitation robot.

13. The sanitation monitoring and control system of claim 12, wherein the sanitation robot is configured to provide sanitation services including at least one of sweeping, vacuuming, and emptying trash receptacles.

14. The sanitation monitoring and control system of claim 11, wherein the network of sensors comprises a plurality of antennas disposed at different locations throughout the facility, and wherein patron positions are determined according to wireless communications between the plurality of antennas and devices carried by the patrons.

15. The sanitation monitoring and control system of claim 11, wherein the network of sensors comprises a plurality of imaging devices disposed at different locations throughout the facility, and wherein patron positions are determined at least in part based on processing of images captured by the plurality of imaging devices.

16. The sanitation monitoring and control system of claim 11, wherein the sanitation monitoring and control server is configured to determine, for each respective patron at each of the plurality of different times, a patron activity according to a sequence of positions of the respective patron in the facility over time, and to determine numbers of patrons engaging in each respective activity in each respective area at each respective time by counting a number of patrons in the respective area at the respective time having the respective activity determined therefor.

17. A sanitation monitoring and control method for routing sanitation resources in a facility, the method comprising:
storing in one or more databases, by a sanitation monitoring and control server communicatively connected to a network of sensors disposed at different locations throughout the facility and configured to sense patrons within the facility, records identifying positions of patrons in the facility at a plurality of different times determined according to the patron sensing information provided by the network of sensors;
determining, by the sanitation monitoring and control server, for each respective area of a plurality of areas in the facility, a number of patrons in the respective area at each of the plurality of different times;
determining, by the sanitation monitoring and control server, for each respective area of the plurality of areas and each of different respective activities, numbers of patrons engaging in the respective activity in the respective area at each of the plurality of different times;
calculating, by the sanitation monitoring and control server, for each respective area of the plurality of areas, a sanitation score for the respective area as a weighted sum of numbers of patrons estimated to engage in the different activities in the area, wherein the different activities are assigned different weights in the weighted sum;
calculating, by the sanitation monitoring and control server, based on the sanitation scores calculated for the plurality of areas, a route for the sanitation resource; and
transmitting, from the sanitation monitoring and control server, the calculated route to a sanitation resource configured to provide sanitation services to control the sanitation resource to provide the sanitation services along the calculated route.

18. The sanitation monitoring and control method of claim 17, wherein the transmitting the calculated route comprises transmitting the calculated route to the sanitation resource comprising a sanitation robot configured to move autonomously in the facility and to communicate wirelessly with the sanitation monitoring and control server, and
the method further comprises controlling the sanitation robot to provide sanitation services including at least one of sweeping, vacuuming, and emptying trash receptacles.

19. The sanitation monitoring and control method of claim 17, further comprising:
receiving, through a plurality of antennas disposed at different locations throughout the facility, wireless communications between the plurality of antennas and devices carried by the patrons; and
determining patron positions according to the received wireless communications between the plurality of antennas and devices carried by the patrons,
wherein the storing the records in the one or more databases comprises storing records identifying the patron positions determined according to the received wireless communications.

20. The sanitation monitoring and control method of claim 17, further comprising:
determining, for each respective patron at each of the plurality of different times, a patron activity according to a sequence of positions of the respective patron in the facility over time,
wherein the determining numbers of patrons engaging in each respective activity in each respective area at each respective time comprises counting a number of patrons in the respective area at the respective time having the respective activity determined therefor.
